(19) United States
(12) Patent Application Publication
(10) Pub. No.: US 2007/0051024 A1
(43) Pub. Date: Mar. 8, 2007

(54) Advertising carrier

(76) Inventors: Fritz Fuchs, Uster (CH); Rene Ruttimann, Lenzerheide (CH); Mauro Pedretti, Biasca (CH); Rolf Luchsinger, Uster (CH)

Correspondence Address: JENKENS & GILCHRIST, PC, 1445 ROSS AVENUE, SUITE 3200, DALLAS, TX, 75202, US

(21) Appl. No.: 10/573,338

(22) PCT Filed: Sep. 13, 2004
(86) PCT No.: PCT/CH04/00573

§ 371 Date: Jun. 5, 2006

(30) Foreign Application Priority Data
Sep. 26, 2003 (CH) 01645/03

(51) Int. Cl. G09F 15/00

(52) U.S. Cl. 40/610

(57) ABSTRACT

The invention relates to a pneumatic advertising medium which comprises at least one pneumatic structural element (1). This structural element is vertically erect in the form of a column and the entire peripheral surface can be used as an advertising medium in the manner of an advertising pillar. At least three compression elements (3) distributed across the hollow body comprise at least one respective pair of traction elements (4) that are wound around the hollow body in the opposite direction and provide the column's flexural strength relative to the wind forces attacking the column from all directions. The compression elements (3) can for example be configured as dismountable elements, thereby simplifying their transport. They are either linked with a base plate (5) which in turn is linked with the support in a nonpositive fit or the column is secured by means of bracing wires that are anchored in the ground and fixed to the compression elements (3).

This invention relates to an advertising carrier consisting of pneumatic structural elements according to the preamble of claim 1.

Flat surfaces, and surfaces that can be clamped flat, are particularly suitable as advertising carriers, also referred to in the following an advertising or projection surfaces. Either advertising or projection surfaces such as those mentioned are erected for a certain period of time, or their erection is intended for a short or temporary period only.

EP 0 699 261 (D1) discloses such an advertising or projection surface which is anchored on one side to the bottom, in the manner of a strip of canvas, and is supported on the other side by a bar. Many such possibilities are of course conceivable.

The task of erecting an advertising and projection surface becomes onerous when such a surface is large in size, whether its purpose is the projection of cinema films or television broadcasts, or for the showing of advertisements at major events.

According to the prior art masts must then be erected and anchored, between which the actual advertising or projection surface is clamped.

The object of this invention consists in providing a large advertising or projection surface which can easily be transported and can be quickly erected and dismantled at minimal labour cost.

The achievement of this object is described in the characterising section of claim 1 in regard to its main characteristics, and in the following claims in regard to further advantageous designs.

The object of the invention is explained in greater detail with reference to the attached drawings, where

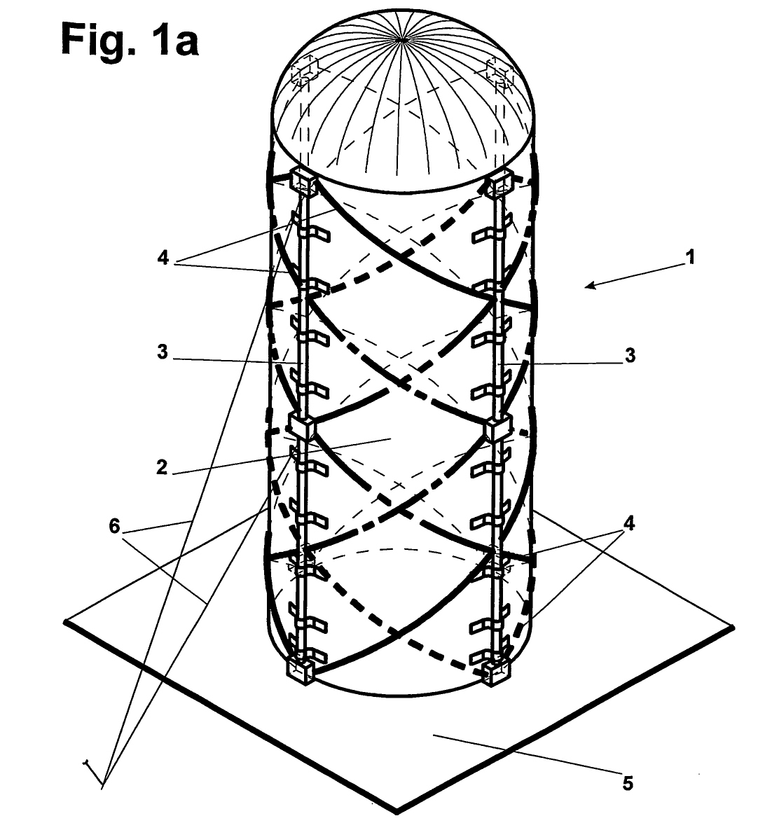

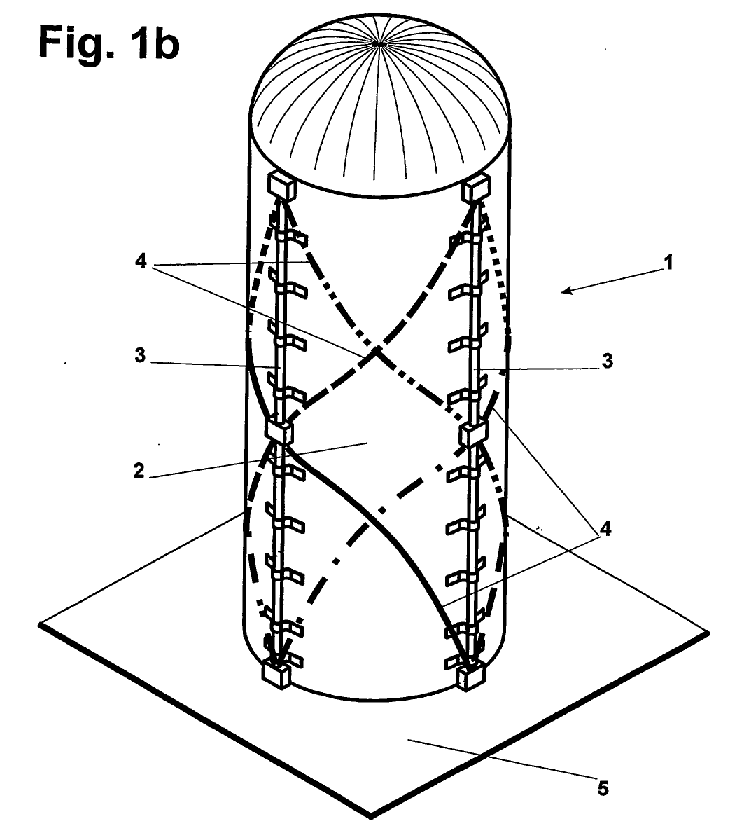

FIG. 1a, b shows an isometric representation of the Supporting structure of a first embodiment of a pneumatic advertising or projection surface,

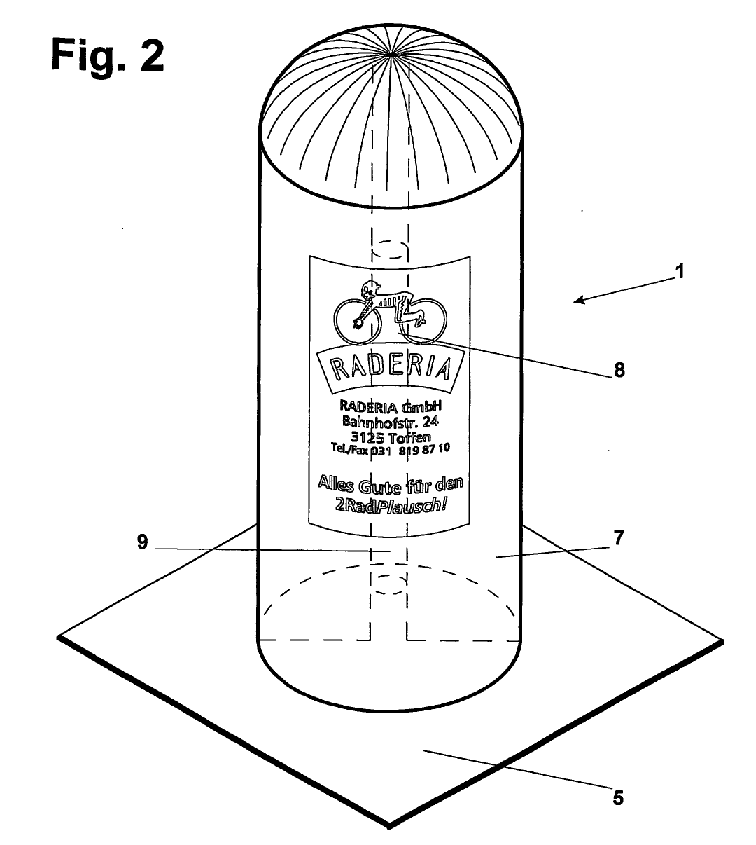

FIG. 2 shows an isometric representation of a first embodiment of a pneumatic advertising or projection surface with a coated cover,

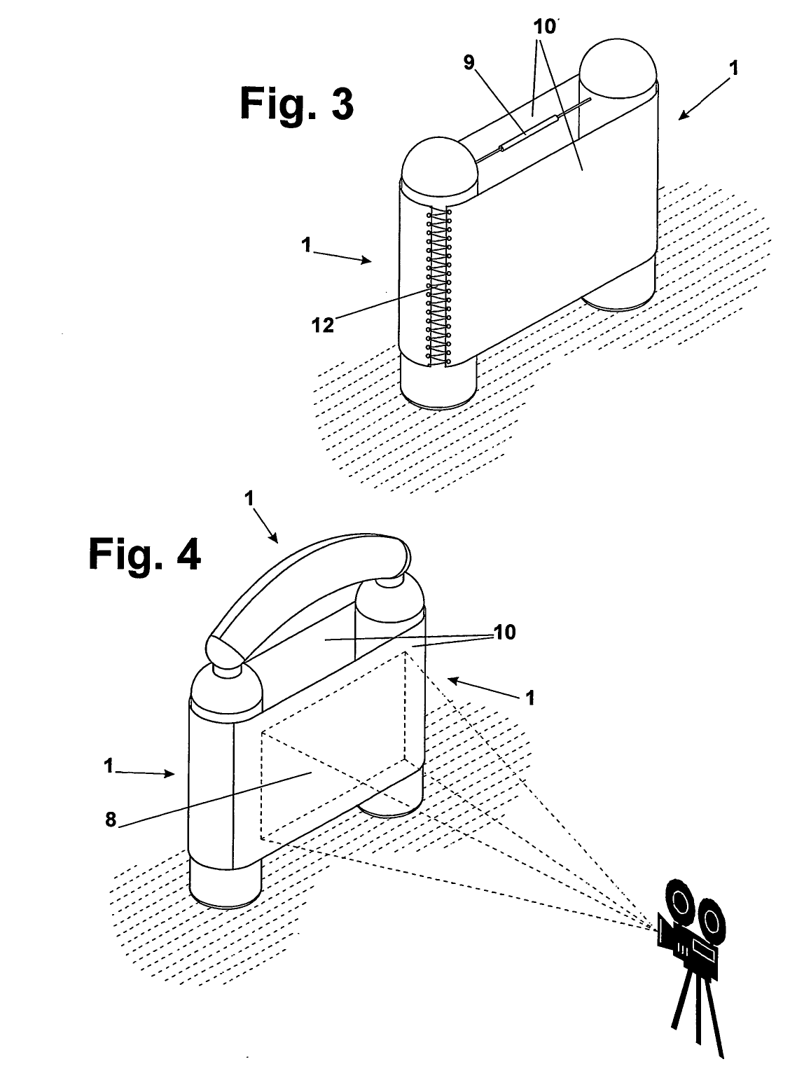

FIG. 3 shows a second embodiment of an advertising or projection surface with two pneumatic structural elements in an isometric representation,

FIG. 4 shows a third embodiment of an advertising or projection surface with three pneumatic structural elements in an isometric representation,

FIG. 5 shows a fourth embodiment of an advertising or projection surface with a tripod as pneumatic structural elements in an isometric representation,

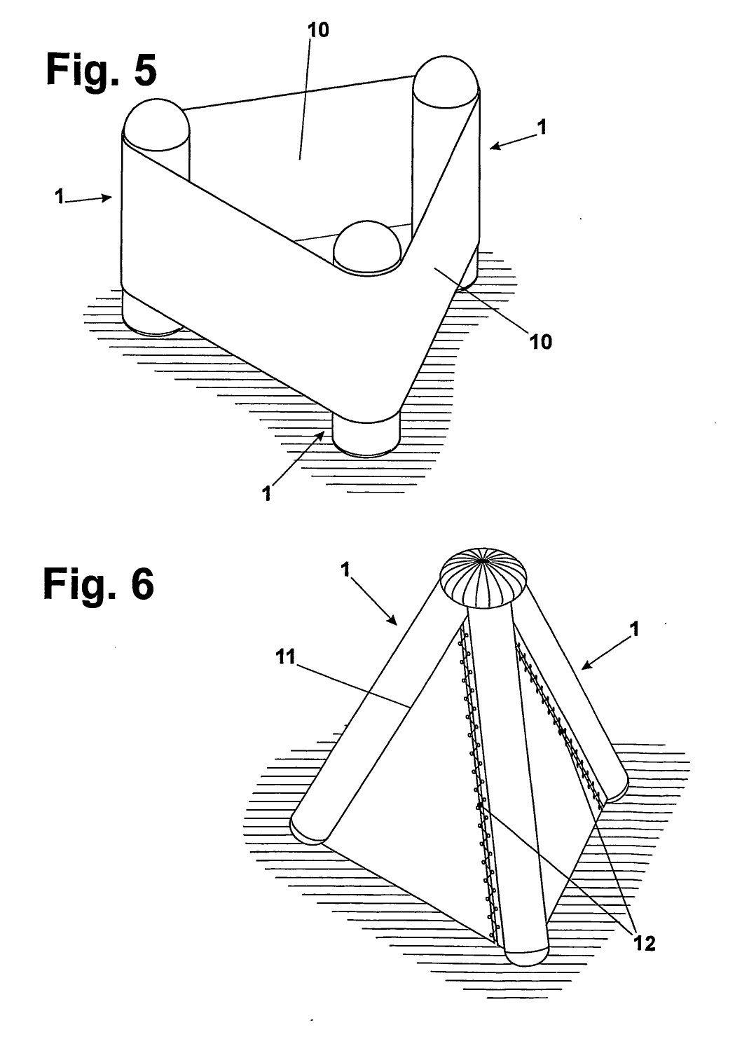

FIG. 6 shows a fifth embodiment of an advertising or projection surface with two pneumatic structural elements in an isometric representation,

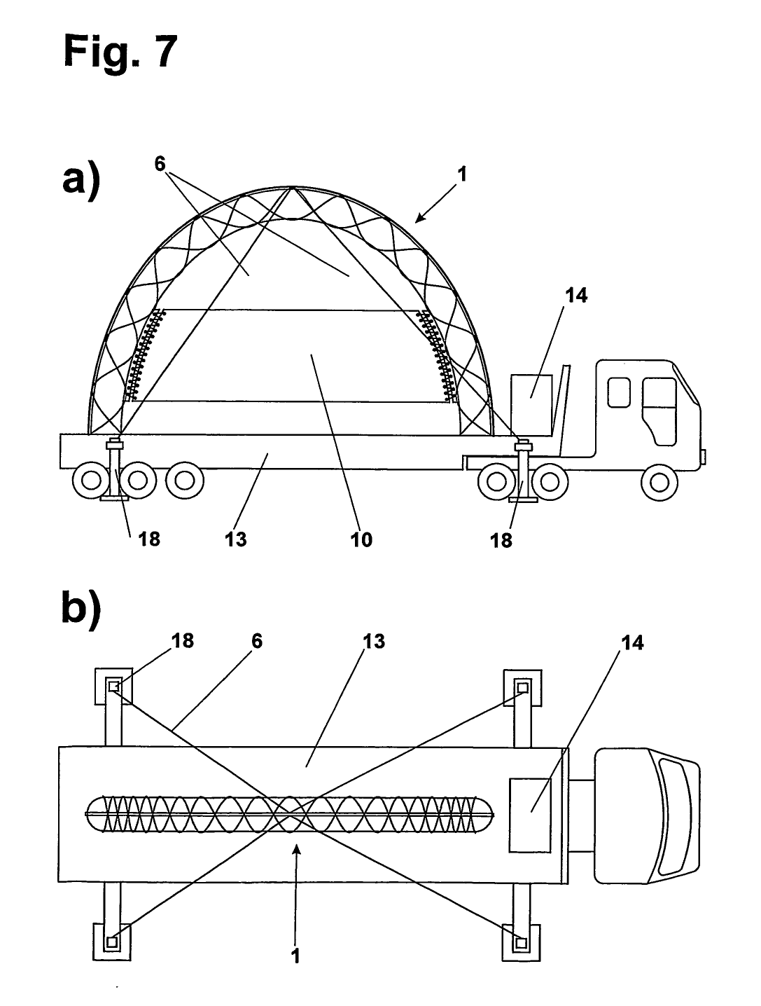

FIG. 7a, b show a sixth embodiment of an advertising or projection surface with an arch-shaped pneumatic structural element on a mobile base, in side and plan view,

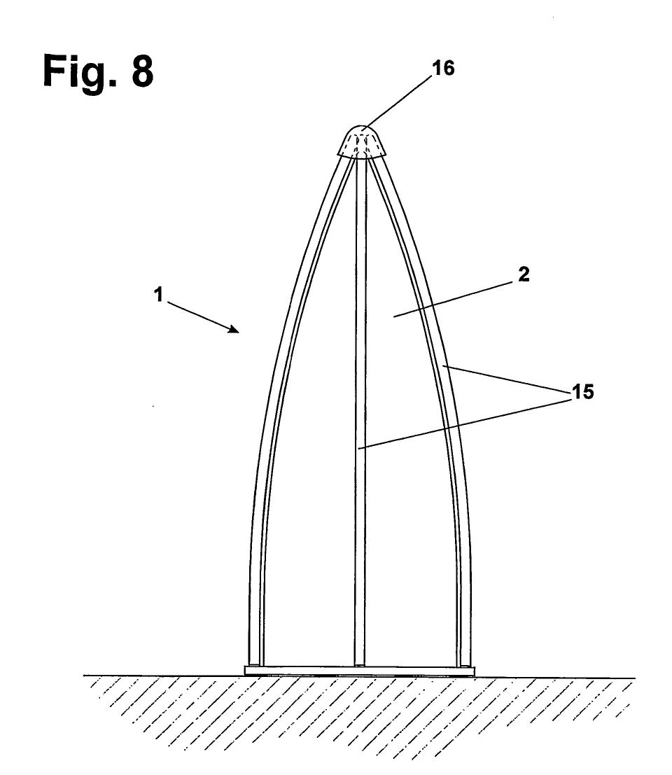

FIG. 8 shows a seventh embodiment of a pneumatic advertising or projection surface in side view,

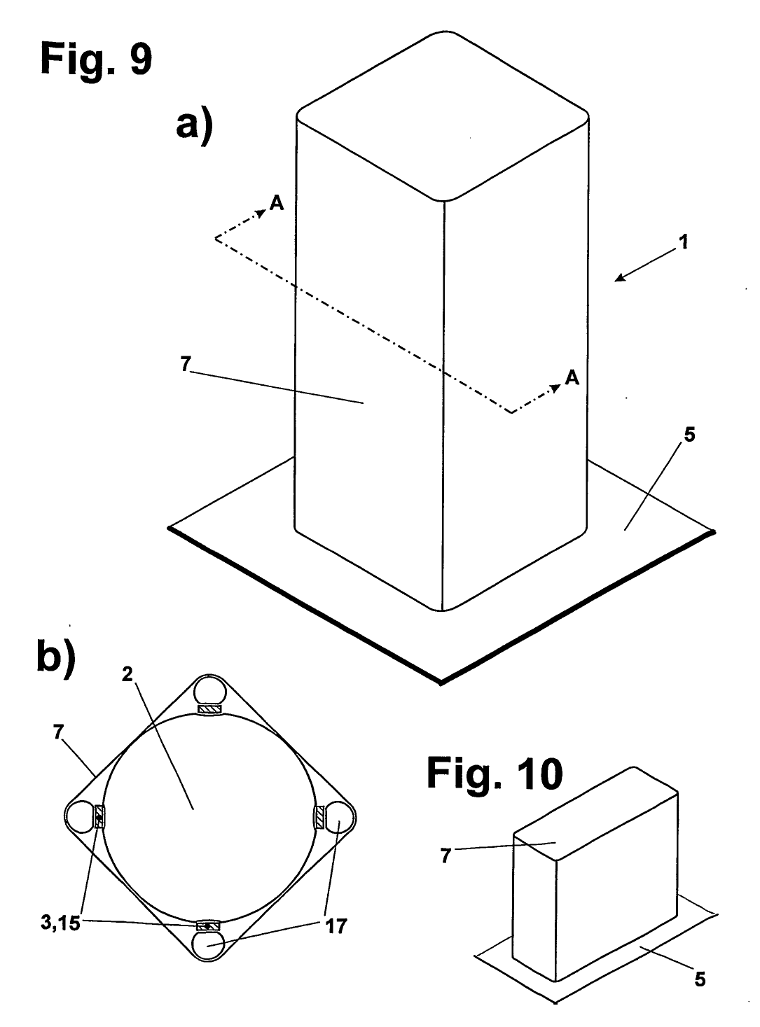

FIG. 9 shows an eighth embodiment of an advertising or projection surface as an isometric representation, and in cross-section,

FIG. 10 shows a ninth embodiment of an advertising or projection surface in isometric representation,

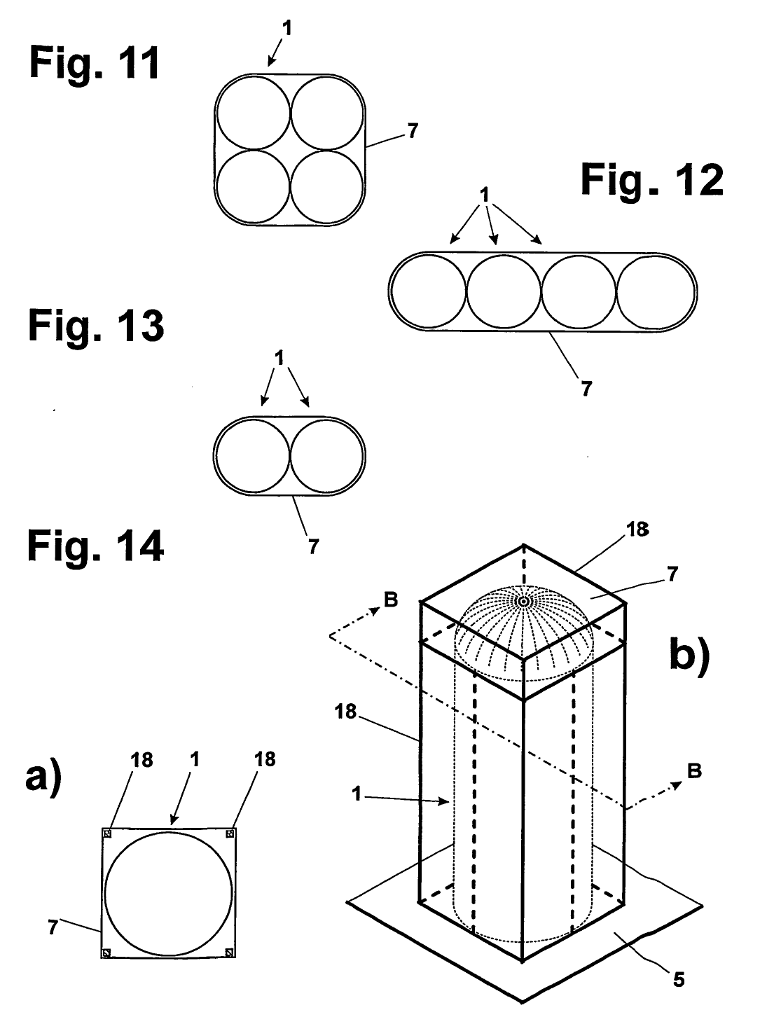

FIGS. 11-13 shows diagrammatic representations of further embodiments in cross-section,

FIG. 14a, b show a thirteenth embodiment of an advertising or projection surface with a bar scaffold in cross-section and as an isometric representation, and

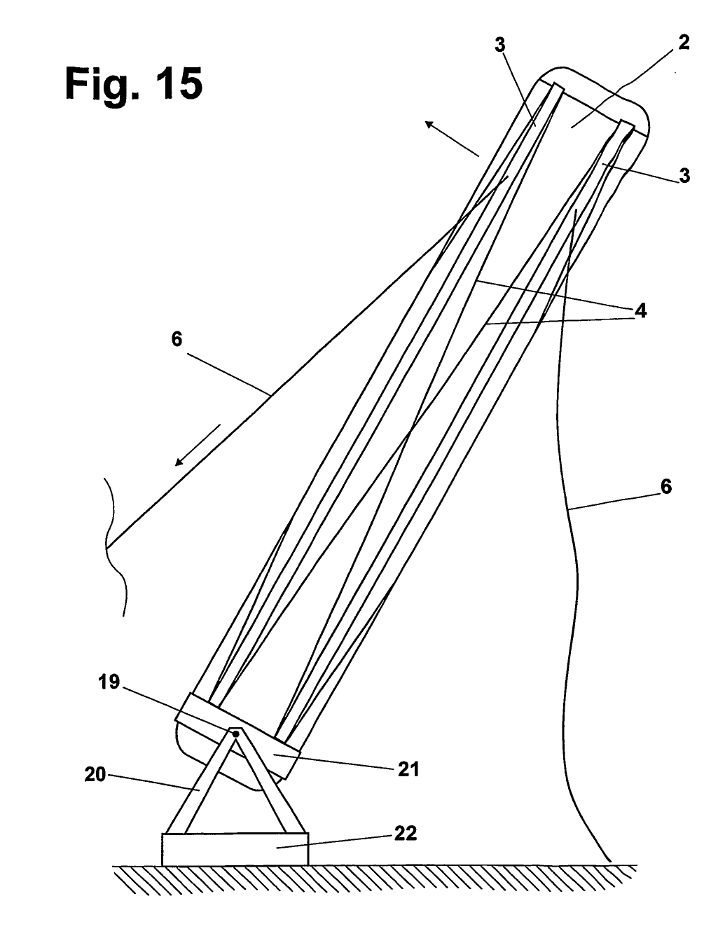

FIG. 15 shows a fourteenth embodiment of an advertising or projection surface with a hinged joint.

FIG. 1 shows a first embodiment of an advertising or projection surface consisting of a pneumatic structural element 2. The state of the art for pneumatic structural elements 1, which are constructed from a hollow element 2 and tension and/or pressure elements, is disclosed among other things in the following patent applications: WO 01/73245 (D2), PCT/CH2004/00112 (D3) and PCT/CH2004/000384 (D4). A common feature of the pneumatic structural elements 1 in all these aforementioned applications is that the compressive and tensile forces generated under transversal load are absorbed by elements specifically provided for this purpose and not by hollow element 2 loaded with compressed air. This design enables light, bending resistant pneumatic structural elements 1 to be provided which can be erected and dismantled in a short time and with few personnel. Pneumatic structures without pressure and tension elements in a size that is desirable for advertising or projection surfaces must, if they are to have large cross-sections without anchoring ropes, be loaded with high pressures of several bars to prevent them from being buckled by the wind forces generated in gusts of wind. Such high pressures imply not only more stringent material requirements imposed on hollow element 2, but a certain risk potential if the hollow element cover is damaged. Hollow elements 2 of structural elements used in this disclosure are only loaded with an air pressure ranging from 5 mbars to 1000 mbars.

FIG. 1a represents a pneumatic structural element 1, referred to in the following, for the sake of simplicity, to structural element 1, according to Document D2. It is erected vertically as a column and the entire surface area can be used as an advertising carrier in the manner of an advertising column. Four pressure bars 3, distributed around the hollow element, each with a minimum of one pair of associated tension elements 4, wound in opposite directions around the hollow element, provide the bending resistance of the column against attacking wind forces from all directions. Pressure bars 3 may, for example, be designed so that they can be dismantled to facilitate transport. They are either connected on a base plate 5 positively connected in turn to the standing base, or the column is secured by means of tension ropes 6 anchored in the base and fastened to pressure bars 3, as shown in FIG. 1a on one side for illustration purposes. If a base plate 5, positively connected to pressure bars 3, is dispensed with, tension ropes 6 must obviously be fitted on all four pressure bars 3, or the pressure bars must be positively secured directly on the base, for example by means of screws. If structural element 1 is positively connected to base plate 5 or directly to the base, tension elements 4 need only guided, advantageously, around hollow element 2 in half a revolution, as shown in FIG. 1b. Tension elements 4 may, for example, be secured directly to base plate 5 the surface of hollow element 2 may now be used directly as an advertising surface, or advertising message 8 may be applied on an cover 7, which can in turn be pulled over the column. FIG. 2 shows the first embodiment with cover 7 pulled over. The same advertising column may therefore carry different advertising messages 8 at little expense. It is within the spirit of the invention that a change of cover and hence of advertising message can also be made on a column mounted upright. For example, several covers 7 can be pulled over structural element 1, and can be rolled in and out by means of a suitable device or removed one after the other from structural element 1. For applications in the dark the column can either be illuminated on the outside or lighting means 9, for example light emitting diodes of different colours, are secured inside hollow element 2, for example on flexible bridges clamped in hollow element 2, whereby the column can be illuminated from the inside.

The column may be folded up for transport after allowing the air to escape. Depending on the type of pressure bars 3, these must be removed beforehand. However, if structural elements 1 are constructed with flexible pressure bars 3, as disclosed in PCT/CH2004/000111 (D5), pressure bars 3 may be left on hollow element 2 for transport. FIGS. 3 to 6 show variants of pneumatic advertising or projection surfaces produced by combining several structural elements 1 according to FIGS. 1 and 2. They clamp additional surfaces 10 or are all covered with replaceable covers 7 carrying advertising messages or serving as projection surfaces.

FIG. 3 shows how two structural elements 1 according to FIG. clamp a surface 10. This surface 10 may be used as a screen for projections, or advertising messages 8 may be projected onto it. The clamped surface 10 may either be clamped in a single layer between structural elements 1 or, as shown in FIG. 3, it may be guided around structural elements 1, which results in a two-layer surface 20. Here the distance separating the two surfaces 10 is equal to the diameter of structural elements 1. Lighting means 9 may be installed between or behind surface(s) 10, enabling transparent advertising messages 8 to be background illuminated at night. Obviously advertising messages 8 may also be projected from the front by means of searchlights. It is known to the person skilled in the art that these two different methods of lighting require different materials for surface 10 and different colours for advertising message 8. Means for modifying the lighting, both the light intensity and the light colour, enable the attractiveness of the advertising message to be enhanced and increases the focus of attention of the public through the advertising messages in hours of darkness or twilight.

In the embodiment in FIG. 4 two structural elements 1 used as columns are connected by an additional structural element 1 and form an arch- or gate-shaped structure. The technical construction of the connection of several structural elements 1 represents the state of the art and is known to the person skilled in the art.

FIG. 5 shows a three-column model with surfaces 10, serving as advertising or projection surfaces, on three sides.

The inventive concept embraces suitable designs with more than three columns on the one hand, and with additional, stabilising structural elements 1 connecting structural elements 1 used as columns, for example at the upper ends, according to D3, D3 or D4.

The tripod in FIG. 6 is provided with three surfaces 10 serving as advertising and projection surfaces. These triangular surfaces 10, used for example as screens for back-projections from the inside of the tripod, may for example be connected to structural element 1 along one of the legs by means of keder joint 12, whilst a clamping device 12 on the other leg of the screen triangle, for example on a pressure bar 3 of structural element 1, is used to clamp surface 10 flatly and free from folds. A pneumatic clamping device may also be used as clamping device 12, as disclosed, for example, in DE 100 17 104 (D6).

FIG. 7 shows an arch-shaped structural element 1 according to Document D3. A textile surface 10 is clamped in the arch. In this embodiment the advertising carrier stands on a truck trailer 13. The mobility of this and all preceding and following embodiments may be considerably increased if the advertising carriers are erected on a mobile base, for example on a truck, a raft or a ship. On trailer 13, all operating means 14, such as compressed air pump, current generator, projector, light and sound system, are provided which are necessary for a mobile marketing system. For lateral stabilisation of the arch truck trailer 13 is provided with laterally extendible supports 18. These counteract tipping of the arch together with truck trailer 13. It may also be necessary to weigh down truck trailer 13 with additional ballast, for example concrete weights, water or sand, in order to increase tipping stability. The only requirement imposed with regard to the site of erection, when erecting the advertising carrier on a truck trailer 13, is that a suitable truck trailer 13 can be parked in that location. Neither the base nor surrounding buildings must receive tension ropes 6.

Different devices by means of which different advertising messages 8 can be shown on the erected advertising carrier in a certain time sequence are known to the person skilled in the art. This is comparable, for example, to the devices used for strip advertising in football stadiums, where a surface printed with advertising messages 8 is wound from a first roll to a second roll, and where new advertising messages 8 are continuously presented on the visible surface between the rolls. This method of conveying changing advertising messages 8 has an advantage over the projection of images or films in bright daylight because of better visibility.

FIG. 8 shows a structural element 1 constructed according to Document D4. At least three elements which, in the longitudinal direction, may receive both compressive and tensile forces, referred to in the following as pressure/tension elements 15, are positively secured to an essentially circular base plate 5, which is manufactured from steel, for example, and converge at the apex of a light arch, where they are in turn positively connected by means of a connecting piece 16. The pressure/tension elements 15 enclose hollow element 2 and are connected positively to it along generating lines. All the above-mentioned embodiments, with several structural elements 1, may also be composed of structural elements shown in FIG. 8. If connecting piece 16 has similar dimensions to the base area of structural element 1, a structural element 1 of this design may also assume a cylindrical instead of the conical shape shown.

FIGS. 9a, b show an eighth embodiment of an advertising and projection surface. Pneumatic structures are generally round in shape. More angular shapes may be produced, for example, by providing the covers of hollow elements 2 with bridges secured on the inside. Although the use of bridges renders the production of hollow elements more expensive and complicated, a structural element 1 with pressure/tension elements 15, according to FIG. 8, is possible. FIGS. 9a, b show a different method of providing structural elements 1 with more cornered or angular shapes. Section AA in FIG. 9b shows that edge elements 17 are secured to the four pressure bars 3 or pressure/tension elements 15, projecting outwards, for example by gluing or by means of several straps distributed along the entire length of edge element 17. Edge elements 17 project in cross-section from the circumference of hollow element 2, thus defining an approximately square column outline when an elastic or tailored cover 7 is pulled over structural element 1 widened in that manner. FIG. 9a shows edge elements 17 in the form of pressure-loaded hoses. Thus the corner of the columns is still slightly rounded. Even more cornered structural elements 1 may be produced by means of edge profiles of soft plastics, where these edge profiles may either be glued to pressure-loaded hoses or may be used in isolation as edge elements 17.

FIG. 10 shows the combination of two structural elements 1, as shown in FIGS. 9a, b. Cover 7 incorporates both structural elements and forms a wide, rectangular surface 10.

Complex shaped advertising carries may be constructed by means of several structural elements 1, a suitably cut cover 7 and, if necessary, with additional pressure-loaded hoses and hollow elements, as well as edge elements 17, for example in the form of a product to be advertised. FIGS. 11-13 show diagrammatically further embodiments of advertising and projection surfaces in which several structural elements 1 are arranged directly adjacent to each other or behind each other, and are covered by a cover 7. In an arrangement such as that shown in FIG. 12, the two central structural elements 1 may, for example, have only two laterally fitted tension bars 3, whilst structural elements 1 are provided on the edge of the advertising carrier with at least three pressure bars 3, wherein structural elements 1 may be connected positively to each other along their lines of contact to increase the stability of the advertising carrier.

FIGS. 14a, b show a second possibility of erecting advertising or projection surfaces with an angular outer shape in cross-section and as an isometric representation. A shaping bar scaffold 18 is fitted over the supporting structural element 1, this bar scaffold 18 being secured, for example, to pressure bars 3 of structural element 1. Bar scaffold 18 consists, for example, of light metal sections such as those used in exhibition construction, or of fibre-reinforced plastics. Bar scaffold 18 has the added advantage that cover 7 may be constructed, for example, in several parts, and cover 7 is secured to bar scaffold 18 by means of a keder joint or rubber blocks, and can be pulled onto the scaffold on the advertising carrier.

One or more interconnected structural elements 1 together form a supporting structure which can be used as advertising carriers, whether by means of covers 7 that are pulled over and carry advertising messages 8, by clamping a surface 10 or by widening the supporting structure in such a manner that it assumes the shape of a product to be advertised.

An important advantage of all the above-mentioned pneumatic advertising and projection surfaces is, among other things that they can be erected in minutes instead of hours, and can be dismantled just as quickly. This avoids tedious, and in any case expensive approval procedures normally required for large advertising areas at major events. For example, the advertising and projection surfaces are constructed horizontally on the ground, then erected with the aid of hydraulic lifting devices, pull cables, or even a crane, for example. To facilitate the erection of an advertising and projection surface constructed horizontally on the ground and loaded with compressed air, its lower end can be secured on at least one bearing 20 by means of at least one hinged joint 19. This enables the advertising or projection surface to be erected from the horizontal position by means of a rope winch, via tension ropes 6, or by means of hydraulic cylinders, for example.

FIG. 15 shows an embodiment with hinged joint 19. In this embodiment a ring 21, which encloses hollow element 2 at the lower end, and to which pressure/tension elements 15 are positively connected, assumes part of the function of base plate 5.

Pressure/tension elements 15 are secured to ring 21 instead of to a base plate 5, and the ring is pivoted on bearing 20, which stands on a base 22 resting solidly on the ground or is anchored to the ground.

A plate, a cross, frame or half-shell may also be used, for example, instead of a ring 21. Interesting effects are possible if means are provided for tilting the advertising or projection surface from the perpendicular during operation, then realigning it. The same means may be used for this purpose as those used for erecting the advertising or projection surface, provided that a hinged joint 19 is provided. Alternatively, the advertising or projection surface may be provided with at least one swivelling and tilting device which serves exclusively to draw the attention of the public by moving the advertising or projection surface, for example by creating the impression of something crashing onto the advertising or projection surface.

1. An advertising carrier consisting of at least one structural element (1),
with a gas-tight, elongated hollow element (2) that can be loaded with pressure gas and consists of a flexible material,
additionally with at least two pressure/tension elements (15),
wherein the at least two pressure/tension elements (15) are connected positively to each other at their ends,
and wherein the pressure/tension elements (5) that can be pressure loaded rest on the hollow element (2) along its generating line, and are positively connected to it,
Characterised in that
the surface of at least one of hollow elements (2) is designed as a surface (10) that can be used as an advertising or projection surface.

2. The advertising carrier according to claim 1, characterised in that at least one of the at least three pressure/tension elements (15) only absorbs tensile forces, and is therefore designed as a pure tension element (4).

3. The advertising carrier according to claim 2, characterised in that at least one pair of tension elements (4) are wound around the hollow element (2) in the opposite direction of screwing in at least half a revolution or a multiple.

4. The advertising carrier according to one of claims 1 to 3, characterised in that at least one structural element (1) clamps at least one flexible membrane to at least one flat surface (10) that can be used as an additional advertising or projection surface.

5. The advertising carrier according to one of claims 1 to 4, characterised in that the pressure-loadable pressure/tension elements (15) rest on the hollow element (2) along one of its generating lies, and are positively connected to the hollow element (2).

6. The advertising carrier according to one of claims 1 to 5, characterised in that the supporting structure is covered with a cover (7) designed as an advertising or projection surface.

7. The advertising carrier according to one of claims 1 to 6, characterised in that the supporting structure is formed from several structural elements (1) connected to each other on the longitudinal side.

8. The advertising carrier according to one of claims 1 to 7, characterised in that it is anchored laterally with at least three tension ropes (6).

9. The advertising carrier according to one of claims 1 to 8, characterised in that that at least one structural element (1) is positively connected to a base plate (5).

10. The advertising carrier according to one of claims 1 to 9, characterised in that lighting means (19), which illuminate structural element (1) from the inside, are incorporated inside a hollow element (2).

11. The advertising carrier according to one of claims 1 to 10, characterised in that lighting means (9) are provided behind at least one surface (10) clamped by at least one structural element (1).

12. The advertising carrier according to one of claims 1 to 11, characterised in that it can be transported and erected on a mobile base.

13. The advertising carrier according to claim 12, characterised in that means (14) required for independent operation of the advertising carrier are provided on the mobile base.

14. The advertising carrier according to claim 13, characterised in that the means (14) consist at least of
a device for generating compressed air or
a device for erecting the advertising carrier or
a device for generating electrical current or
a projector for films and still images or
a device for illumination or
a sound system.

15. The advertising carrier according to one of claims 1 to 14, characterised in that the device for erecting the advertising carrier consists
of at least one hinged joint (19) for tilting the pressure loaded advertising carrier from a horizontal position to an upright position,
and of at least one actor for performing this tilting movement.

16. The advertising carrier according to claim 15, characterised in that means are provided for automatically performing tilting movements during the operation of the advertising carrier.

17. The advertising carrier according to claims 1 to 16, characterised in that several structural elements (1), together with the cover (7), form a shape that identifies the project to be advertised.

18. The advertising carrier according to one of claims 1 to 17, characterised in that at least one edge element (17) is secured on the outside to at least one structural element (1), whereby the advertising carrier, with a cover (7) pulled over it, has at least a partially angular shaped appearance.

19. The advertising carrier according to claim 18, characterised in that at least one edge element (17) consists of a hollow element of a flexible material that can be loaded with compressed air.

20. The advertising carrier according to claim 18 or 19, characterised in that at least one of the edge elements (17) has an edge profile of soft plastic.

21. The advertising carrier according to claim 18, characterised in that the edge elements (17) are formed by a bar scaffold (18), wherein the bar scaffold (18) surrounds at least one structural element (1), thereby defining, together with a cover (7), an angular outer shape of the advertising carrier.

22. The advertising carrier according to claim 21, characterised in that covers (7) provided with advertising messages (8) can be pulled onto the erected bar scaffold (18) and can then be let down again.

23. The advertising carrier according to one of claims 1 to 22, characterised in that the advertising carrier has an essentially freely designable shape.

24. The advertising carrier according to one of claims 1 to 23, characterised in that means are provided for changing advertising messages (8) and showing them one after the other when the advertising carrier is erected.
